(19) United States
(12) Patent Application Publication
(10) Pub. No.: US 2010/0071119 A1
(43) Pub. Date: Mar. 25, 2010

(54) YARNS AND FABRICS THAT SHED LIQUIDS, GELS, SPARKS AND MOLTEN METALS AND METHODS OF MANUFACTURE AND USE

(75) Inventor: Tyler M. Thatcher, Salt Lake City, UT (US)

Correspondence Address: Workman Nydegger;1000 Eagle Gate Tower, 60 East South Temple, Salt Lake City, UT, 84111, US

(73) Assignee: Chapman Therman Products, Inc., Salt Lake City, UT (US)

(21) Appl. No.: 12/627,911

(22) Filed: Nov. 30, 2009

Related U.S. Application Data
(63) Continuation-in-part of application No. 11/691,248, filed on Mar. 26, 2007.
(60) Provisional application No. 60/786,853, filed on Mar. 29, 2006.

(51) Int. Cl. A62B 17/00; B32B 5/02; D02G 3/36

(52) U.S. Cl. 2/458; 442/148; 428/378; 2/81

(57) ABSTRACT

Fire retardant and heat resistant yarns and fabrics include a fabric or yarn comprised of oxidized polyacrylonitrile at least partially coated or encapsulated by a strengthening polymer material that helps the fabric or yarn shed liquids, gels, sparks, and molten metals. The polymer material includes one or more types of cured silicone polymer resin. A fluorochemical may be at least partially impregnated into the fabric or yarn prior to applying the strengthening polymer material in order to further enhance the shedding properties of the yarns or fabric. In one embodiment, the silicone polymer resin only coats or encapsulates the yarn, but does not form a continuous coating over the whole fabric, so that the treated fabric is still able to breath through pores and spaces between individual yarn strands that make up the fabric. The polymer material increases the strength, abrasion resistance, durability and shedding capability of the fire retardant heat resistant yarn or fabric.

### CROSS-REFERENCE TO RELATED APPLICATION

This application is a continuation-in-part of co-pending U.S. patent application Ser. No. 11/691,248, filed Mar. 26, 2007, which claims the benefit under 35 U.S.C. §119 of U.S. provisional application Ser. No. 60/786,853, filed Mar. 29, 2006, the disclosures of which are incorporated herein in their entirety.

### BACKGROUND OF THE INVENTION

1. The Field of the Invention

The present invention is in the field of fire retardant and heat resistant yarns and fabrics. More particularly, the present invention is in the field of fire retardant and heat resistant yarns comprised of oxidized polyacrylonitrile fibers and coated with a liquid-shedding, gel-shedding, spark-shedding and molten metal-shedding and strengthening polymer, as well as fabrics and articles of manufacture made therewith.

2. The Relevant Technology

Fire retardant clothing is widely used to protect persons who are exposed to fire, particularly suddenly occurring and fast burning conflagrations. These include persons in diverse fields, such as race car drivers, military personnel, fire fighters, and metal workers, each of which may be exposed to deadly fires, heat, and extremely dangerous incendiary conditions. For such persons, the primary line of defense against severe burns and even death is the protective clothing worn over some or all of the body.

Even though fire retardant clothing presently exists, such clothing is not always adequate to reliably offset the risk of severe burns, or even death. This is particularly true in the case where a person is not only exposed to flame or high heat but splashed with a flammable hydrocarbon liquid (e.g., gasoline), sparks or molten metal. Flammable hydrocarbon liquid spashing could occur, for example, in the case of a vehicle crash or by deliberate sabotage (e.g., a Molotov cocktail or other incendiary device hurled at a policeman or military personnel). Splashing of sparks and molten metal could occur, for example, in the case of welders and steel or other metal workers who routinely handle molten metal as it is poured and otherwise transported to manufacture finished steel and other metal products.

A wide variety of different fibers and fibrous blends have been used in the manufacture of fire and heat resistant fabrics. Fire retardance, heat resistance, strength and abrasion resistance all play an important role in the selection of materials used to make such fabrics. However, it is difficult to satisfy all of the foregoing desired properties. There is often a compromise between fire retardance and heat resistance, on the one hand, and strength and abrasion resistance, on the other.

Conventional fire retardant fabrics on the market typically rate very high in one, or perhaps two, of the foregoing desired properties. One example is a proprietary fabric m-aramid fabric sold by DuPont, which rates high in strength and abrasion resistance at room temperature but only provides protection against high temperatures and flame for a relatively short period of time. When exposed to direct flame, the leading m-aramid “fire retardant” fabric begins to shrink and char in as little as 3 seconds, and the degradation of the fabric increases as the duration of exposure increases. Ironically, it is the tendency of m-aramid fabrics to char and shrink that is purported to protect the wearer's skin from heat and flame. M-aramid fabrics may protect the wearer from burns for several seconds, but becomes essentially worthless as a protective shield after it has begun to char, shrink and decompose. Once this occurs, large holes can open up through which flame, heat, sparks, and molten metal can pass, thus burning, or even charring, the naked skin of the person wearing the fabric. Fabrics based on p-aramid are also strong and resist abrasion at room temperature but also char and shrink when exposed to flame or high temperature.

Flammable fabrics such as cotton, polyester, rayon, and nylon have been treated with a fire retardant finish to enhance fire retardance. While this may temporarily increase the flame retardant properties of such fabrics, typical fire retardant finishes are not permanent. Exposure of the treated fabric to UV radiation (e.g., sun light) as well as routine laundering of the fabric can greatly reduce the fire retardant properties of the fabric. The user may then have a false sense of security, thus unknowingly exposing himself to increased risk of burns. There may be no objective way to determine, short of being caught in a fiery conflagration or similarly dangerous environment, whether a treated garment still possesses sufficient fire retardance to offset the risks to which the wearer may be exposed.

More recently, a range of highly fire retardant and heat resistant yarns and fabrics comprised of oxidized polyacrylonitrile fibers blended with one or more strengthening fibers were developed. Yarns and fabrics made exclusively from oxidized polyacrylonitrile fibers lack adequate strength for use in many applications. Blending oxidized polyacrylonitrile fibers with one or more types of strengthening fibers yields yarns and fabrics having increased strength and flexibility. U.S. Pat. Nos. 6,287,686 and 6,358,608 to Huang et al. disclose a range of yarns and fabrics that preferably include about 85.5-99.9% by weight oxidized polyacrylonitrile fibers and about 0.1-14.5% by weight of one or more strengthening fibers. U.S. Pat. No. 4,865,906 to Smith, Jr. includes about 25-85% oxidized polyacrylonitrile fibers combined with at least two types of strengthening fibers. For purposes of teaching fire retardant and heat resistant yarns, fabrics and articles of manufacture, the foregoing patents are incorporated herein by reference.

Highly flame retardant and heat resistant fabrics made according to the Huang et al. patents are sold under the name CARBONX by Chapman Thermal Products, Inc., located in Salt lake City, Utah. Such fabrics are able to resist burning or charring even when exposed to a direct flame. Fabrics made according to the Huang et al. and Smith, Jr. patents are not only superior to m-aramid as far as providing fire retardance and heat resistance, but they are softer, have higher breathability, and are better at absorbing sweat and moisture. CARBONX “feels” much like an ordinary fabric made from natural or natural feeling synthetic fibers. M-aramid fabric, in contrast, feels more like wearing a plastic sheet than a fabric since it does not breathe well, nor does it wick sweat and moisture, but sheds it readily. Unfortunately, the aspect of CARBONX that makes it feel most like an ordinary fabric—its ability to absorb sweat, moisture and liquid—does not aid in shedding flammable liquids, molten metals, and sparks.

Some applications may require a level of tensile strength, abrasion resistance, and durability not provided by conventional fire retardant fabrics. One way to improve such features is to incorporate a metallic filament, such as is disclosed in U.S. Pat. No. 6,800,367 to Hanyon et al., the disclosure of which is incorporated by reference. Including a metal filament also increases the cut resistance of the fabric. Nevertheless, adding a metallic filament may increase the ability of a fabric to transfer heat, and it does not appreciably increase the ability of the fabric to shed flammable liquids, gels, molten metals, or sparks.

Accordingly, it would be an advancement in the art to provide fire retardant and heat resistant yarns that were able to maintain a high level of fire retardance and heat resistance while having improved tensile strength, abrasion resistance, durability, and the capability to shed flammable liquids, gels, sparks, and molten metals.

### BRIEF SUMMARY OF THE INVENTION

The present invention encompasses novel yarns and fabrics that include a high concentration of oxidized polyacrylonitrile (O-Pan) fibers, which maintain a high level of fire retardance and heat resistance, while also possessing improved tensile strength, abrasion resistance, durability, and the ability to shed liquids, gels, sparks, and molten metals. The inventive yarns include O-Pan fibers, typically combined with one or more strengthening fibers, and are coated on at least the exterior surface of the resulting fabric by a strengthening coating, such as a silicone polymer that further aids in shedding of liquids, gels, sparks, and molten metals. In one embodiment, all surfaces of the yarn are coated, encapsulating the yarn. Coating or encapsulating the fire retardant and heat resistant yarn or fabric with a silicone polymer increases the tensile strength, abrasion resistance, durability, and shedding capability of the yarn, as well as fabrics and articles made from such yarn.

The present invention combines the tremendous fire retardant and heat resistant characteristics of yarns made from O-Pan fibers with the strengthening and shedding properties imparted by a liquid-resistant polymer coating capable of shedding liquids and gels. Furthermore, the combination of the polymer coating and O-Pan fibers unexpectedly results in a yarn and fabric capable of shedding hot materials such as sparks and molten metals. Simply coating or encapsulating the yarn of a conventional flammable fabric with a silicone polymer coating cannot yield a fabric having a flame retardance and heat resistance that is even remotely similar to the level provided by O-Pan based fabrics. Moreover, coating or encapsulating aramid-based materials with a liquid, spark, and molten metal-resistant and strengthening silicone polymer coating does not alter the inherent tendency of fabrics formed from such materials to char, shrink, and form holes when exposed to direct flame and/or heated to above 600° F. Only by combining the tremendous fire retardant and heat resistant properties of O-Pan based fabrics with the strengthening aspects and shedding capabilities offered by coating at least the outer surface of the yarn or fabric that may come into contact with flammable liquids, molten metal, or sparks can true synergy be obtained (i.e., the ability to provide the highest level of fire retardance and heat resistance to a fabric, while also providing enhanced tensile strength, abrasion resistance, durability, and liquid, gel, spark, and molten metal shedding capabilities, all of which synergistically contribute to the ability of the fabric to protect a wearer from fire and heat).

The failure to provide all of these features in a single fabric can greatly undermine the otherwise excellent protection from fire. For example, even though conventional CARBONX fabrics provide superior protection against fire, heat and burns compared to other leading fire resistant fabrics such as the leading aramid “fire retardant” fabrics, such protection can be compromised if the fabric lacks sufficient tensile strength, abrasion resistance and durability for a given application. The fabric will typically only protect the wearer to the extent the fabric is able to maintain its structural integrity when protection is needed most, i.e., a fabric designed to protect the skin advantageously remains positioned between the wearer's body and the heat source to provide maximum protection. An inadvertent hole or tear can provide a conduit through which heat and flame can breach the otherwise continuous protective shield. Because of the generally weaker nature of O-Pan based fabrics compared to conventional fabrics, coating or encapsulating the yarn comprising O-Pan based fabrics with a strengthening polymer provides a much greater incremental benefit with regard to tensile strength, abrasion resistance, and durability compared to conventional fabrics which are stronger to begin with. Coating or encapsulation of the O-Pan based yarn with a liquid shedding polymer also greatly increases the ability of the O-Pan based fabric to shed liquids and gels, including flammable liquids and gels as well as sparks and molten metal. This shedding capability is important as it more quickly removes the heat source from the exterior of the fabric so as to prevent heat transfer through the fabric to the wearer's skin.

Thus, coating or encapsulating the yarn of O-Pan based fabrics with a liquid/gel/spark/molten metal-resistant and strengthening polymer reduces the tendency of such fabrics to form holes or tears while protecting the wearer from flame and heat, and it helps such fabrics to shed liquids and gels, including flammable liquids and gels that can engulf the wearer in flames if absorbed into the fabric. Such encapsulation is also effective in providing the fabric with the ability to shed sparks or molten metal that may otherwise remain on the fabric, transferring heat through the fabric to the underlying skin or forming a hole. Coating or encapsulation of the O-Pan based yarn with a liquid/gel/spark/molten metal-resistant and strengthening polymer coating greatly increases the range of situations where O-Pan based fabrics can provide superior protection from heat and flame as intended, even though the liquid-shedding, spark-shedding, and molten metal-shedding and strengthening polymer may not itself provide any significant incremental heat or flame resistance beyond that which is already provided by the O-Pan based fabric. The high level of heat and flame resistance is provided mainly or exclusively by the O-Pan based fabric. The coating or encapsulation of the O-Pan yarn comprising the fabric with a liquid/gel/spark/molten metal-resistant and strengthening polymer coating mainly provides the auxiliary benefits of increased tensile strength, abrasion resistance, durability, and shedding capability (e.g., flammable liquids and gels, sparks, and molten metal). Nevertheless, the overall protection to the wearer against flame and heat is greatly enhanced by the auxiliary benefits imparted by coating or encapsulating the yarn with a liquid/gel/spark/molten metal-resistant and strengthening polymer coating, demonstrating the synergistic effect of combining O-Pan based fabrics with polymer coating of the yarn comprising the fabric.

Additional strength and abrasion resistance can be provided by blending one or more types of strengthening fibers with the O-Pan fibers used to make the yarn. Strengthening fibers do not possess the level of fire retardance and heat resistance as O-Pan fibers but can be used to strengthen the yarn while maintaining an adequate level of fire retardance and heat resistance in the yarn. Exemplary “strengthening fibers” include, but are not limited to, polybenzimidazole (PBI), polybenzoxazole (PBO), polyphenylene-2,6-benzobisoxazole (PBO), modacrilic, p-aramid, m-aramid, polyvinyl halides, wool, fire resistant polyesters, fire resistant nylons, fire resistant rayons, cotton, and melamine. The oxidized polyacrylonitrile fibers and the strengthening fibers are each first preferably carded into respective strands or carded together to form a blended strand. Multiple strands may then be intertwined together to form a yarn. Alternatively, the yarn may include strengthening filaments made from the same materials as the foregoing strengthening fibers. Even ceramic or metal filaments may be included, though they may be unnecessary in view of the greatly increased tensile strength, abrasion resistance and durability imparted by coating or encapsulating the yarn with the strengthening and shedding polymer.

Exemplary liquid/gel/spark/molten metal-resistant and strengthening polymer coatings include a wide variety of curable silicone-based polymers and polysiloxanes. According to one embodiment, such polymers are encapsulated over the individual yarn strands of a tensioned fabric that is drawn through a bath of shear thinned polymer resin. Thereafter, the polymer resin is cured to form the final encapsulated yarn. This process advantageously only encapsulates the yarn strands but leaves spaces between the yarn strands that are woven or knitted together so as to permit the treated fabric to breathe. In this way, the treated fabric still feels and behaves more like an ordinary fabric rather than a laminate sheet or plugged fabric.

The yarn may be coated or encapsulated with the liquid/gel/spark/molten metal-resistant and strengthening coating after being woven or knitted into a fabric. Alternatively, it is within the scope of the invention to coat or encapsulate the yarn before forming it into a fabric. According to one method, individual yarn strands can be encapsulated by drawing them through a bath of shear thinned polymer composition and then curing the polymer. Alternatively, the yarn or fabric substrate may be coated by a knife coating method. According to an exemplary knife coating method, the uncured polymer composition may be applied to the tensioned fabric, which then passes through a gap between a knife and a support roller. As the tensioned fabric substrate passes through the gap, the excess polymer composition is scraped off by the knife, further ensuring that the uncured polymer composition is evenly spread over individual yarns, resulting in proper coating. Because the fabric is under tension, the exposed surface of the individual yarn strands are coated, but spaces between yarn strands are not, so as to permit the treated fabric to breath and feel more like an ordinary fabric rather than a plugged fabric. Such a method may be used to coat only one side of a fabric. Of course, in embodiments where only one side of a fabric is coated, the coated side of the fabric becomes the protected exterior surface of the article of manufacture made from the fabric which exhibits the shedding ability, so that the exterior surface of the article is able to shed liquids, gels, sparks and molten metal. According to another embodiment, both sides of the fabric are coated. In order to completely encapsulate the fabric substrate, the fabric may be processed again so as to coat the opposing surface of the fabric. It may also be possible to operate multiple knives simultaneously so as to coat both sides of a fabric in a single operation.

Non-limiting examples of articles of manufacture made using the liquid, spark, and molten metal-resistant polymer treated O-Pan yarns and fabrics include clothing, jump suits, gloves, socks, welding bibs, welding sleeves, welding mask shrouds (e.g., to protect the neck), breacher's coats, fire blankets, padding, protective head gear, linings, undergarments, bedding, drapes, and the like.

According to one embodiment, the yarn or fabric may be pre-treated with a fluorochemical prior to coating or encapsulation with the polymer coating. Pre-treatment with a fluorochemical may assist in helping the polymer coated yarn or fabric to repel or shed liquids and gels, such as water and hydrocarbons as well as other dangerous environmental hazards such as sparks and molten metal. The fluorochemical may advantageously be applied as a suspension or solution in combination with a solvent that is driven off by evaporation. Thereafter, the silicone polymer is applied to the yarn or fabric in order to coat or encapsulate the yarn strands or fabric substrate. The fluorochemical is at least partially impregnated into the yarn.

These and other advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a perspective view of the testing apparatus used to evaluate heat transfer characteristics of a sample of fabric to be evaluated;

FIG. 2 is a perspective view of the testing apparatus of FIG. 1 with molten iron being poured onto the sample fabric;

FIG. 3 is a schematic side view of the testing apparatus of FIG. 2;

FIG. 4A is a graph showing temperature rise as a function of time while testing an O-Pan based fabric that is not coated or encapsulated in silicone;

FIG. 4B is a graph showing total heat energy transfer as a function of time of the same O-Pan based fabric evaluated in FIG. 4A;

FIG. 5A is a graph showing temperature rise as a function of time while testing an O-Pan based fabric that is encapsulated in silicone; and

FIG. 5B is a graph showing total heat energy transfer as a function of time of the same silicone encapsulated O-Pan based fabric evaluated in FIG. 5A.

### DETAILED DESCRIPTION OF THE PREFERRED EMBODIMENTS

### I. Introduction and Definitions

The present invention encompasses fire retardant and heat resistant yarns and fabrics in which the yarn is coated or encapsulated by a liquid/gel/spark/molten metal-resistant and strengthening coating to yield fabrics and articles that provide better tensile strength, abrasion resistance, durability, and the ability to shed liquids, gels, sparks, and molten metal compared to fabrics in the absence of such yarn coating or encapsulation. Coating or encapsulating the individual yarn strands (i.e., so as to maintain empty space between individual strands), rather than coating and plugging the whole fabric (i.e., in which space between strands is plugged with polymer and strands become glued together), not only seals the individual yarn strands in superior fashion, it also maintains breathability of the fabric.

By combining the tremendous fire retardant and heat resistant properties of O-Pan based fabrics with the strengthening and liquid/gel/spark/molten metal-shedding aspects offered by the disclosed coating, a synergistic combination is obtained (i.e., the high level of fire retardance and heat resistance of the fabric, coupled with enhanced tensile strength, abrasion resistance, durability, and shedding capabilities of the coating, synergistically contribute to the ability of the fabric to protect a wearer from fire and heat). The failure to provide all of these features in a single fabric can greatly undermine the otherwise excellent protection from fire, i.e., the fabric will typically only protect the wearer to the extent the fabric is able to maintain its structural integrity and remove the heat source when protection is needed most.

Because of the generally weaker nature of O-Pan based fabrics compared to conventional fabrics, coating or encapsulating the yarn comprising O-Pan based fabrics provides a much greater incremental benefit with regard to tensile strength, abrasion resistance, and durability compared to conventional fabrics which are stronger to begin with. Coating of the O-Pan based yarn also greatly increases the ability of the O-Pan based fabric to shed liquids and gels (e.g., flammable liquids and gels such as hydrocarbon fuels) as well as sparks and molten metal. This ability to quickly shed such materials results in removal of the heat source from the fabric, which protects the fabric from degradation and limits the amount of heat transferred through the fabric to the wearer's skin.

The term “Limiting Oxygen Index” (or “LOI”) is defined as the minimum concentration of oxygen necessary to support combustion of a material. The LOI is primarily a measurement of flame retardancy rather than temperature resistance. Temperature resistance is typically measured as the “continuous operating temperature”.

The term “continuous operating temperature” measures the maximum temperature, or temperature range, at which a particular fabric will maintain its strength and integrity over time when exposed to constant heat of a given temperature or range. For instance, a fabric that has a continuous operating temperature of 400° F. can be exposed to temperatures of up to 400° F. for prolonged periods of time without significant degradation of fiber strength, fabric integrity, and protection of the user. In some cases, a fabric having a continuous operating temperature of 400° F. may be exposed to brief periods of heat at higher temperatures without significant degradation. The presently accepted standard for continuous operating temperature in the auto racing industry rates fabrics as being “flame retardant” if they have a continuous operating temperature of between 375° F. to 600° F.

The term “fire retardant” refers to a fabric, felt, yarn or strand that is self extinguishing. The term “nonflammable” refers to a fabric, felt, yarn or strand that will not burn.

The term “Thermal Protective Performance” (or “TPP”) relates to a fabric's ability to provide continuous and reliable protection to a person's skin beneath a fabric when the fabric is exposed to a direct flame or radiant heat. The TPP measurement, which is derived from a complex mathematical formula, is often converted into an SFI rating, which is an approximation of the time it takes before a standard quantity of heat causes a second degree burn to occur.

The term “SFI Rating” is a measurement of the length of time it takes for someone wearing a specific fabric to suffer a second degree burn when the fabric is exposed to a standard temperature. In the auto racing industry, the SFI Rating is printed on a driver's suit. The SFI Rating is not only dependent on the number of fabric layers in the garment, but also on the LOI, continuous operating temperature and TPP of the fabric or fabrics from which a garment is manufactured. The standard SFI Ratings are as follows:

| SFI Rating | Time to Second Degree Burn |
|---|---|
| 3.2A/1 | 3 Seconds |
| 3.2A/3 | 7 Seconds |
| 3.2A/5 | 10 Seconds |
| 3.2A/10 | 19 Seconds |
| 3.2A/15 | 30 Seconds |
| 3.2A/20 | 40 Seconds |

A secondary test for flame retardance is the after-flame test, which measures the length of time it takes for a flame retardant fabric to self extinguish after a direct flame that envelopes the fabric is removed. The term “after-flame time” is the measurement of the time it takes for a fabric to self extinguish. According to SFI standards, a fabric must self extinguish in 2.0 seconds or less in order to pass and be certifiably “flame retardant”.

The term “tensile strength” refers to the maximum amount of stress that can be applied to a material before rupture or failure. The “tear strength” is the amount of force required to tear a fabric. In general, the tensile strength of a fabric relates to how easily the fabric will tear or rip. The tensile strength may also relate to the ability of the fabric to avoid becoming permanently stretched or deformed. The tensile and tear strengths of a fabric should be high enough so as to prevent ripping, tearing, or permanent deformation of the garment in a manner that would significantly compromise the intended level of thermal protection of the garment.

The term “abrasion resistance” refers to the tendency of a fabric to resist fraying and thinning during normal wear. Although related to tensile strength, abrasion resistance also relates to other measurements of yarn strength, such as shear strength and modulus of elasticity, as well as the tightness and type of the weave or knit.

The terms “fiber” and “fibers” refers to any slender, elongated structure that can be carded or otherwise formed into a thread. Fibers typically have a length of about 2 mm to about 75 mm and an aspect ratio of at least about 100:1. Examples include “staple fibers”, a term that is well-known in the textile art. The term “fiber” differs from the term “filament”, which is defined separately below and which comprises a different component of the inventive yarns.

The term “thread”, as used in the specification and appended claims, shall refer to continuous or discontinuous elongated strands formed by carding or otherwise joining together one or more different kinds of fibers.

The term “filament” shall refer to a thread of indefinite length, whether comprising multiple fibers or a monofilament.

The term “yarn” shall refer to a continuous strand comprised of a multiplicity of fibers, filaments, or the like in bundled form, such as may be suitable for knitting, weaving or otherwise used to form a fabric.

The term “fabric” shall refer to an article of manufacture formed by knitting, weaving or otherwise joining a plurality of yarn strands together to form a multi-dimensional structure used to manufacture a wide variety of useful articles.

The terms “coat”, “outer layer”, “encapsulate” and “outer shell” shall refer to the positioning or placement of a liquid-shedding, spark-shedding, and molten metal-shedding polymer material over or around an inner core comprising a yarn strand, before or after the yarn is formed into a fabric. The terms “coat”, “outer layer”, “encapsulate” and “outer shell” refer to the fact that at least some of the liquid/gel/spark/molten metal-shedding polymer material is located on an outer perimeter of the yarn strand(s). They do not mean that some of the liquid/gel/spark/molten metal-shedding polymer material that “coats” or “encapsulates” the inner yarn core cannot also be located in interstitial spaces or pores within the inner yarn core. According to some embodiments, the polymer material may only coat one side of a fabric (e.g., as accomplished by knife coating) rather than coating both sides so as to encapsulate the fabric with an outer shell. The terms “coat” and “outer layer” describe such embodiments. In single side coated embodiments, the coated outer layer surface becomes the exterior of the article of manufacture, so that when the coated surface is contacted by any liquids, gels, sparks, or molten metal, the fabric is able to shed these materials, protecting the wearer. The uncoated surface is inwardly oriented so as to contact the wearer's body or underclothes.

The term “inner core” shall refer to the fire retardant and heat resistant yarn that is coated or encapsulated by the liquid/gel/spark/molten metal-resistant and strengthening polymer.

### II. Fire Retardant and Heat Resistant Yarns and Fabrics

Fire retardant and heat resistant yarns according to the invention typically comprise at least one type of fire retardant and heat resistant fibers and/or filaments, preferably combined or blended with at least one type of strengthening fibers and/or filaments. Fire retardant and heat resistant fibers can be carded into a yarn, either alone or in combination with one or more types of strengthening fibers. Multiple yarns can be twisted or braided together to form a larger yarn strand. One or more fire retardant and heat resistant yarns comprising mainly or solely fire retardant and heat resistant fibers or filament(s) can be twisted or braided together with one or more strengthening strands comprising mainly or solely strengthening fibers and/or filament(s). Because a yarn strand typically consists of multiple strands twisted or braided together, it will typically include a substantial amount of interstitial space between the individual strands, at least before being coated or encapsulated by the liquid/gel/spark/molten metal-shedding polymer.

Fabrics comprising the fire retardant and heat resistant yarns can be formed by knitting, weaving or otherwise combining multiple strands of yarn together. Any known method of forming a fabric from a yarn can be utilized to form the inventive fire retardant and heat resistant fabrics. Exemplary fire retardant and heat resistant yarns, fabrics and articles that can be improved according to the present invention are disclosed in U.S. Pat. Nos. 6,287,686, 6,358,608, 6,800,367 and 4,865,906. For purposes of disclosing fire retardant and heat resistant yarns and fabrics capable of being coated or encapsulated according to the invention, the disclosures of the foregoing patents are incorporated by reference.

A. Fire Retardant and Heat Resistant Fibers and Filaments

Exemplary fire retardant and heat resistant fibers and filaments are made from oxidized polyacrylonitrile (O-Pan). The O-Pan fibers or filaments within the scope of the invention may comprise any type of O-Pan having high fire retardance and heat resistance. In a preferred embodiment, O-Pan is obtained by heating polyacrylonitrile (e.g., polyacrylonitrile fibers or filaments) in a cooking process between about 180° C. to about 3000° C. for at least about 120 minutes. This heating/oxidation process is where the polyacrylonitrile receives its initial carbonization. Preferred O-Pan fibers and filaments have an LOI of about 50-65. In most cases, O-Pan made in this way may be considered to be nonflammable.

Examples of suitable O-Pan fibers include LASTAN, manufactured by Ashia Chemical in Japan; PYROMEX, manufactured by Toho Rayon in Japan; PANOX, manufactured by SGL; and PYRON, manufactured by Zoltek. It is also within the scope of the invention to utilize filaments that comprise O-Pan.

In general, it is believed that fabrics which include a substantial amount of O-Pan fibers and/or filaments will resist burning, even when exposed to intense heat or flame exceeding 3000° F., because the O-Pan fibers carbonize and expand, thereby eliminating any oxygen content within the fabric necessary for combustion of the more readily combustible strengthening fibers. In this way, the O-Pan fibers or filaments provide a combustion shield that makes the less fire retardant substances in the yarn or fabric act like better fire retardant substances.

One of skill in the art will appreciate that other fire retardant and heat resistant materials can be used in addition to, or in place of, O-Pan so long as they have fire retardant and heat resistance properties that are comparable to those of O-Pan. By way of example, polymers or other materials having an LOI of at least about 50 and which do not burn when exposed to heat or flame having a temperature of about 3000° F. could be used in addition to, or instead of, O-Pan.

The fire retardant and heat resistant yarn comprising the fabric portion of the overall liquid, gel, spark, and molten metal shedding article may consist solely of O-Pan fibers or filaments. When the O-Pan is blended with one or more strengthening fibers or filaments, O-Pan is preferably included in an amount in a range of about 25% to about 99.9% by weight of the fabric or yarn (exclusive of the polymer coating), more preferably in a range of about 40% to about 95% by weight, and most preferably in a range of about 50% to about 90% by weight of the fabric or yarn (exclusive of the polymer coating).

B. Strengthening Fibers and Filaments

Strengthening fibers and filaments that may be incorporated into fire retardant and heat resistant yarns, fabrics and articles of the present invention may comprise any fiber or filament known in the art. In general, preferred strengthening fibers will be those that have a relatively high LOI and TPP compared to natural organic fibers such as cotton, although the use of such fibers is within the scope of the invention. The strengthening fibers preferably have an LOI greater than about 20.

Strengthening fibers may be carded or otherwise formed into yarn, either alone or in combination with other fibers (e.g., O-Pan fibers). Strengthening yarns or filaments may be twisted, braided or otherwise combined with fire retardant and heat resistant strands to form a blended yarn.

Strengthening fibers and filaments within the scope of the invention include, but are not limited to, polybenzimidazole (PBI), polybenzoxazole (PBO), polyphenylene-2,6-benzobisoxazole (PBO), modacrilic, p-aramid, m-aramid, polyvinyl halides, wool, fire resistant polyesters, fire resistant nylons, fire resistant rayons, cotton, linen, and melamine. By way of comparison with O-Pan, which has an LOI of about 50-65, the LOI's of selected strengthening fibers are as follows:

| | |
|---|---|
| PBO | 68 |
| PBI | 35-36 |
| modacrylic | 28-32 |
| m-Aramid | 28-36 |
| p-Aramid | 27-36 |
| wool | 23 |
| polyester | 22-23 |
| nylon | 22-23 |
| rayon | 16-17 |
| cotton | 16-17 |

Examples of suitable p-aramids include KEVLAR, manufactured by DuPont; TWARON, manufactured by Twaron Products BB; and TECHNORA, manufactured by Teijin. Examples of suitable m-aramids include NOMEX, manufactured by DuPont; CONEX, manufactured by Teijin; and P84, an m-aramid yarn with a multi-lobal cross-section made by a patented spinning method, manufactured by Inspec Fiber. For this reason P84 has better fire retardant properties as compared to NOMEX.

An example of a PBO is ZYLON, manufactured by Toyobo. An example of a PBI fiber is CELAZOLE of PBI Performance Products, Inc. An example of a melamine fiber is BASOFIL. An example of a fire retardant or treated cotton is PROBAN, manufactured by Westex. Another is FIREWEAR.

Strengthening fibers and filaments may be incorporated in the yarns of the present invention in at least the following ways: (1) as one or more strengthening filaments twisted, wrapped, braided or otherwise joined together with threads or filaments comprising oxidized polyacrylonitrile; or (2) as fibers blended with O-Pan fibers into one or more yarns.

In short, strengthening fibers may be added to the inventive yarns in the form of strengthening yarns comprising one or more different types of strengthening fibers, a blended yarn comprising O-Pan fibers and one or more different types of strengthening fibers, or as a strengthening filament. When O-Pan is blended with one or more strengthening fibers or filaments, the strengthening fibers or filaments are preferably included in an amount in a range of about 0.1% to about 75% by weight of the fabric or yarn (exclusive of the polymer coating), more preferably in a range of about 5% to about 60% by weight, and most preferably in a range of about 10% to about 50% by weight of fabric or yarn (exclusive of the polymer coating).

C. Metallic and Ceramic Filaments

Yarns according to the invention may include one or more types of metallic or ceramic filaments in order to increase cut resistance, tensile strength and abrasion resistance. Metallic filaments typically have the highest combination of tensile strength and cut resistance but also conduct heat more rapidly. Examples of metals used to form high strength filaments include, but are not limited to, stainless steel, stainless steel alloys, other steel alloys, titanium, aluminum, copper, and the like.

Examples of high strength ceramic filaments include silicon carbide, graphite, silica, aluminum oxide, other metal oxides, and the like. Examples of high strength and heat resistant ceramic filaments are set forth in U.S. Pat. Nos. 5,569,629 and 5,585,312 to TenEyck et al., which disclose ceramic filaments that include 62-85% by weight SiO₂, 5-20% by weight Al₂O₃, 5-15% by weight MgO, 0.5-5% by weight TiOₓ, and 0-5% ZrO₂. High strength and flexible ceramic filaments based on a blend of one or more oxides of Al, Zr, Ti, Si, Fe, Co, Ca, Nb, Pb, Mg, Sr, Cu, Bi and Mn are disclosed in U.S. Pat. No. 5,605,870 to Strom-Olsen et al. For purposes of disclosing high strength ceramic filaments, the foregoing patents are incorporated herein by reference. Fiberglass filaments can also be used.

Strengthening filaments preferably have a diameter in a range of about 0.0001″ to about 0.01″, more preferably in a range of about 0.0005″ to about 0.008″, and most preferably in a range of about 0.001″ to about 0.006″. Yarns containing a high concentration of oxidized polyacrylonitrile fibers that are generally too weak to be used in the manufacture of fire retardant and heat resistant fabrics can be greatly strengthened with even small percentages of one or more metallic filaments, and fabrics manufactured therefrom have been found to be surprisingly strong.

In general, where it is desired to maximize the strength of the material, it will be preferable to maximize the volume of strengthening filaments that are added to the yarn. However, it will be appreciated that as the amount of strengthening filaments increases in the yarn, the heat resistance generally declines. As a practical matter, the fire retardant and heat resistant requirements of the resulting yarn, fabric or other fibrous blend will determine the maximum amount of strengthening filaments that can be added to the yarn.

### III. Shedding and Strengthened Fire Retardant and Heat Resistant Yarns and Fabrics

The fire retardant and heat resistant yarns and fabrics discussed above can be treated according to the invention by coating or encapsulating the yarn with a shedding and strengthening polymer coating material that sheds liquids, gels, sparks, and molten metal. The shedding and strengthening polymer coating yields yarns, fabrics and articles that are much better at shedding liquids (e.g., flammable liquids), gels (e.g., flammable gels), sparks, and molten metal. In this way, thermal protection to the wearer is further increased when used to protect a wearer exposed to flammable liquids, flammable gels, hot sparks, or molten metals. In addition, polymer coating or encapsulation significantly increases the tensile strength, abrasion resistance and durability of the fire retardant and heat resistant yarns, fabrics and articles of the invention. Increasing the tensile strength, abrasion resistance and durability of a fabric or article also increases the thermal protection of the wearer by reducing the formation of holes or rips through the fabric and increasing the continuity of protection.

Exemplary liquid/gel/spark/molten metal-shedding and strengthening polymer materials, optional compositions applied to yarns in addition to the shedding and strengthening polymer materials, as well as methods for coating or encapsulating yarns with the shedding and strengthening polymer materials, are disclosed in U.S. Pat. Nos. 4,666,765, 5,004,643, 5,209,965, 5,418,051, 5,856,245, 5,869,172, 5,935,637, 6,040,251, 6,071,602, 6,083,602, 6,129,978, 6,289,841, 6,312,523, 6,342,280 and 6,416,613. For purposes of disclosing liquid/gel/spark/molten metal-shedding and strengthening polymer coating materials, as well as methods of applying such materials to a fabric, the disclosures of the foregoing patents are incorporated by reference.

Exemplary liquid/gel/spark/molten metal-resistant and strengthening polymer coatings include a wide variety of curable silicone-based polymers and polysiloxanes. Such polymers are typically applied as an uncured or partially cured polymer resin and then cured (i.e., cross-linked and/or further polymerized) after coating or encapsulating the yarn being treated. The polymer resins before application typically have a viscosity in a range of about 1000 cps to about 2,000,000 cps at a shear rate of 1/10s and a temperature of 25° C. The polymer resins preferably have a viscosity in a range of about 5000 cps to about 10,000 cps at a shear rate of 1/10s and a temperature of 25° C. In a most preferred embodiment, such polymer resins preferably contain less than about 1% by weight of volatile material. When cured, the coating or encapsulating polymers are preferably elastomeric in order to yield a generally flexible yarn, fabric or article.

A preferred class of liquid curable silicone polymer compositions comprises a curable mixture of the following components: (1) at least one organo-hydrosilane polymer or copolymer; (2) at least one vinyl substituted polysiloxane polymer or copolymer; (3) a platinum or platinum containing catalyst; and (4) optionally fillers and additives.

Typical silicone hydrides (component 1) are polymethylhydrosiloxanes which are dimethyl siloxane copolymers. Typical vinyl terminated siloxanes are vinyl-dimethyl terminated or vinyl substituted polydimethyl siloxanes. Typical catalyst systems include solutions or complexes of chloroplatinic acid in alcohols, ethers, divinylsiloxanes, and cyclic vinyl siloxanes.

Particulate fillers can be included to extend and reinforce the cured polymer composition and also improve the thixotropic behavior of the uncured polymer resins.

Exemplary silicone polymer resins that may be used to coat or encapsulate fire retardant and heat resistant yarns according to the invention include, but are not limited to, SILOPREN LSR 2530 and SILOPREN LSR 2540/01, which comprise a vinyl-terminated polydimethyl/siloxane with fumed silica and methylhydrogen siloxane, which are available from Mobay Chemical Co.; SILASTIC 595 LSR, a polysiloxane available from Dow Corning; SLE 5100, SLE 5110, SLE 5300, SLE 5500, and SLE 6108, which are polysiloxanes, and SLE 5106, a siloxane resin solution, all available from General Electric; KE 1917 and DI 1940-30, silicone polymers available from Shin-Etsu; LIQUID RUBBER BC-10, a silicone fluid with silicone dioxide filler and curing agents, available from SWS Silicones Corporation.

The foregoing silicone polymer resins are characterized as having high viscosity. Depending on the method of coating or encapsulation, in order for such polymer resins to properly coat or encapsulate the yarn, they may typically be thinned in some manner to reduce the viscosity so as to flow around the yarn and at least partially penetrate into the interstitial spaces within the yarn. This may be accomplished in any desired manner. According to one embodiment, the polymer resins are subjected to high shearing conditions, which causes them to undergo shear thinning and/or thixotropic thinning. Any suitable mixing blade, combination of blades, or other apparatus capable of applying high shear may be introduced into the vessel containing the polymer resin in order to temporarily reduce the viscosity of the resin before or during application to the yarn or fabric.

According to one method, such polymers may be encapsulated over the individual yarn strands of a tensioned fabric that is drawn through a bath of shear and/or thixotropically thinned polymer resin. Thereafter, the polymer resin is cured to form the final encapsulated yarn. Curing may be carried out using heat to accelerate polymerization and/or cross-linking or the polymer resin. The process advantageously only encapsulates the yarn strands but leaves spaces between the yarn strands that are woven or knitted together so as to permit the treated fabric to breathe. In this way, the treated fabric still feels and behaves more like an ordinary fabric rather than a laminate sheet or plugged fabric.

As an alternative to the above described encapsulation method in which the yarn or fabric is drawn through a bath of shear thinned polymer composition, the shedding polymer composition may be applied by a knife coating method. Generally speaking, in a knife coating method the uncured polymer composition is applied to the tensioned fabric, which then passes through a gap between a knife and a support roller. As the tensioned fabric substrate passes through the gap, the excess polymer composition is scraped off by the knife, further ensuring that the uncured polymer composition is evenly spread over individual yarns, resulting in proper coating. Because the fabric is under tension, the exposed surface of the individual yarn strands are coated, but spaces between yarn strands are not, so as to permit the treated fabric to breath and feel more like an ordinary fabric rather than a plugged fabric. Such a method may be used to coat only one side of a fabric. Of course, in embodiments where only one side of a fabric is coated, the coated side of the fabric becomes the protected exterior surface of the article of manufacture made from the fabric which exhibits the shedding ability, so that the exterior surface of the article is able to shed liquids, gels, sparks and molten metal. Preferably, both sides of the fabric are coated. In order to completely encapsulate the fabric substrate, the fabric may be processed again so as to coat the opposing surface of the fabric. It may also be possible to operate multiple knives simultaneously so as to coat both sides of a fabric in a single operation

According to one embodiment, the silicone polymer resin is blended with a benzophenone (e.g., about 0.3-10 parts by weight of the silicone polymer), examples of which include 2,4-dihydroxybenzophenone (e.g., UVINUL 400, available from BASF), 2-hydroxy-4-methoxybenzophenone (e.g., UVINUL M-40, available from BASF), 2,2′,4,4′-tetrahydroxybenzophenone (e.g., UVINUL D-50, available from BASF), 2,2′-dihydroxy-4,4′-dimethoxybenzophenone (e.g., UVINUL D-49, available from BASF), mixed tetra-substituted benzophenones (e.g., UVINUL 49 D, available from BASF), and 2-ethylhexyl-2-cyano-3,3-diphenylacrylate (e.g., UVINUL N-539, available from BASF).

The silicone polymer resin may also be blended with an accelerator (e.g., Dow Corning 7127 accelerator, a proprietary polysiloxane material) (e.g., 5-10 parts by weight of the silicone polymer resin) just before being applied to the yarn or fabric to promote curing.

The silicone polymer resin may further include various additives in order to impart desired properties to the yarn or fabric. Exemplary additives include UV absorbers, flame retardants, aluminum hydroxide, filling agents, blood repellants, flattening agents, optical reflective agents, hand altering agents, biocompatible proteins, hydrolyzed silk, and agents that affect thermal conductivity, radiation reflectivity, and/or electrical conductivity.

In general, the yarn is typically coated or encapsulated with the liquid, spark, and molten metal-resistant coating after being woven or knitted into a fabric. Nevertheless, it is within the scope of the invention to coat or encapsulate the yarn before forming it into a fabric. One or more individual yarn strands can be encapsulated by drawing them through a bath of shear thinned polymer composition and then curing the polymer. The treated yarn strands may then be knitted, woven or otherwise joined together to form a desired fabric.

The silicone polymer coating is preferably applied to the yarn or fabric in an amount in a range of about 5% to about 200% by weight of the original yarn or fabric, more preferably in an amount in a range of about 10% to about 100% by weight of the original yarn or fabric.

Yarns and fabrics may also be advantageously pre-treated with a fluorochemical prior to being coated or encapsulated by the silicone polymer resin in order to further increase the liquid, gel, spark, and molten metal shedding properties of the yarn or fabric. Exemplary fluorochemical compositions include, but are not limited to, MILEASE F-14N, F-34, F-31× and F-53 sold by ICI Americas, Inc.; PHOTOTEX FC104, FC461, FC731, FC208 AND FC232 sold by Ciba/Geigy; TEFLON polymers such as TEFLON G, NPA, SKF, UP, UPH, PPR, N and MLV, sold by DuPont; ZEPEL polymers such as ZEPEL B, D, K, RN, RC, OR, HT, 6700 AND 7040, also from DuPont; SCOTCHGUARD sold by 3M.

MILEASE F-14 contains approximately 18% perfluoroacrylate copolymer, 10% ethylene glycol, 7% acetone, and 65% water. MILEASE F-31X is a dispersion of fluorinated resin, acetone and water. ZEPEL 6700 is comprised of 15-20% perfluoroalkyl acrylic copolymer, 1-2% alkoxylated carboxylic acid, 3-5% ethylene glycol, and water, and has a pH of 2-5. ZEPEL 7040 is similar to ZEPEL 6700 but further contains 7-8% acetone. SCOTCHGUARD is comprised of aqueously dispersed fluorochemicals in polymeric form.

Liquid repellant fluorochemical compositions are saturated into the fabric or yarn to completely and uniformly wet the fabric or yarn. This may be performed by dipping the fabric or yarn in a bath of liquid composition or padding the composition onto and into the fabric or yarn. After applying the fluorochemical composition to the fabric or yarn, the water (or other liquid carrier) and other volatile components of the composition are removed by conventional techniques to provide a treated fabric or yarn that is impregnated with the dried fluorochemical. In one embodiment, the saturated fabric or yarn is compressed to remove excess composition. It is then heated to remove the carrier liquid by evaporation (e.g., at a temperature of about 130-160° C. for a period of time about 2-5 minutes). If the fluorochemical is curable, heating may also catalyze or trigger curing.

The fluorochemical may also contain a bonding agent in order to strengthen the bond between the fluorochemical and the yarn or fabric to which it is applied. Exemplary bonding agents include Mobay SILOPREN bonding agent type LSR Z 3042 and NORSIL 815 primer.

When included, the fluorchemical is preferably applied in an amount in a range of about 1% to about 10% by weight of the original yarn or fabric, more preferably in an amount in a range of about 2% to about 4% by weight of the original yarn or fabric.

### IV. Examples

The following examples are provided in order to illustrate various embodiments of the invention. Although examples 1-61 are written in present tense and are therefore hypothetical in nature, they are based on testing of a fabric comprising a 70:30 wt % blend of O-Pan and p-aramid that was coated with a proprietary silicone-based polymer coating owned by Nextec Applications Inc., based in Vista, Calif. at the request of the inventor. Examples 1-61 therefore have a high degree of predictive value based on test results conducted by the inventor. Example 62 is written in past tense and describes actual comparative testing of the 70:30 O-Pan and p-aramid coated or encapsulated fabric as compared to an uncoated 70:30 wt % blend of O-Pan and p-aramid.

### Example 1

A fire retardant and heat resistant fabric made from a yarn having a 70:30 wt % blend of O-Pan and p-aramid, respectively, is encapsulated with a liquid, gel, spark, and molten metal shedding and strengthening silicone-based polymer as follows. First, the fabric is placed under tension. Second, the tensioned fabric is drawn through a vessel containing a silicone-based polymer resin. Third, the silicone-based polymer resin is subjected to localized shear-thinning forces produced by a rapidly spinning shearing blade adjacent to a surface of the fabric in order for the shear-thinned resin to encapsulate the yarn of the fabric and at least partially penetrate into interstitial spaces of the yarn. The viscosity of the silicone-based polymer resin is sufficiently low that it does not plug the spaces between the individual yarn strands of the fabric. Fourth, the treated tensioned fabric is removed from the vessel containing the silicone-based polymer resin. Fifth, the treated fabric is heated in order to cure the silicone-based polymer resin and form the strengthening and liquid, gel, spark, and molten metal-shedding coating over the yarn.

The resulting fire retardant and heat resistant fabric comprising silicone polymer encapsulated yarn has increased tensile strength, abrasion resistance, durability and liquid, gel, spark, and molten metal shedding capability compared to the fire retardant and heat resistant fabric in the absence of the silicone polymer. The fabric is therefore better able to protect a person wearing the fabric when exposed to fire, heat, flammable liquids or gels, sparks, and molten metals as compared to the fire retardant and heat resistant fabric prior to being encapsulated with the silicone polymer by better shedding the flammable liquids, gels, sparks, or molten metals and resisting formation of holes through the fabric, thus providing greater continuity of fabric between the wearer's skin and the fire, heat and any remaining flammable liquids, gels, sparks, or molten metals. Because the silicone polymer only encapsulates the individual yarn strands comprising the fabric, but does not plug the holes or spaces between the yarn strands, the treated fabric remains porous and is able to breathe.

### Example 2

A fire retardant and heat resistant fabric made from a yarn having a 60:20:20 wt % blend of O-Pan, p-aramid, and m-aramid, respectively, is treated in the manner discussed in Example 1. The resulting fabric is somewhat stronger and more durable than the fabric obtained in Example 1 as a result of including a blend of strengthening fibers.

### Example 3

A fire retardant and heat resistant fabric made from a yarn consisting of 100% O-Pan is treated in the manner discussed in Example 1. Even though the fabric made from 100% O-Pan is relatively weak and fragile, treatment with the silicone polymer greatly increases the tensile strength, abrasion resistance, and durability so as to be acceptable for applications for which the fabric would otherwise be unacceptable absent the encapsulation treatment.

### Example 4

A fire retardant and heat resistant fabric made from a yarn having a 40:20:20:20 wt % blend of O-Pan, p-aramid, fire retardant wool, and PBI, respectively, is treated in the manner discussed in Example 1. This fabric is significantly stronger to begin with compared to the fabrics of Examples 1-3 as a result of include more strengthening fibers, but is less fire retardant and heat resistant.

### Example 5

A fire retardant and heat resistant fabric made from a yarn having a 60:40 wt % blend of O-Pan and m-aramid, respectively, is treated in the manner discussed in Example 1. This fabric is significantly stronger to begin with compared to the fabrics of Example 1 as a result of include more strengthening fibers, but is less fire retardant and heat resistant.

### Example 6

A fire retardant and heat resistant fabric made from a yarn having a 90:10 wt % blend of O-Pan and PBI, respectively, is treated in the manner discussed in Example 1. This fabric is not as strong as compared to the fabrics of Examples 1, 2, 4 and 5 as a result of including less strengthening fibers, but is more fire retardant and heat resistant as a result of including 10% PBI. Encapsulating this blend with the silicone polymer coating greatly enhances its strength.

### Example 7

A fire retardant and heat resistant fabric made from a yarn having a 60:10:15:15 wt % blend of O-Pan, p-aramid, polyvinyl chloride, and m-aramid, respectively, is treated in the manner discussed in Example 1. This fabric is quite strong as compared to previous examples as a result of including more and more types of strengthening fibers, but is less fire retardant and heat resistant.

### Examples 8-14

The fire retardant and heat resistant fabrics of Examples 1-7 are pretreated with a fluorochemical prior to encapsulation with the silicone polymer. The fluorochemical is saturated into the fabric as a solution or suspension with a solvent. Excess fluorochemical composition is removed from the saturated fabric by applying pressure. Thereafter, the fluorochemical composition is heated in order to remove the solvent by evaporation and dry the fluorochemical. After applying the silicone polymer according to Example 1, the fluorochemical remains at least partially impregnated within the fire retardant and heat resistant fabric.

The fluorochemical further enhances the liquid, gel, spark, and molten metal-shedding properties of the fire retardant and heat resistant fabric beyond what is provided by the silicone polymer encapsulation provided in Examples 1-7. Enhancing the shedding properties of the fire retardant and heat resistant fabric further protects a wearer of the fabric from fire and heat if contacted by sparks, molten metal, or doused with a flammable liquid or gel, such as gasoline.

### Examples 15-33

Various treated fire retardant and heat resistant fabrics are manufactured using any of the fabrics utilized in Examples 1-7. The silicone polymer coating used to treat the fire retardant and heat resistant fabric(s) according to Examples 15-33 are set forth in Table I below. The amount of silicone resin in the polymer coating is in all cases 100 parts. The “mixture ratio” refers to the ratio of packaged components as supplied by the manufacturer.

TABLE I

| | | Mixture | Substituted | | | |
|---|---|---|---|---|---|---|
| Example | Silicone Resin | Ratio | Benzophenone | Parts | Other Additives | Part |
| 15 | Silopren ® | 1:1 | Uvinul 400 | 5 | 7127 | 5/10 |
| | LSR 2530 | | | | Accelerator¹ | |
| 16 | Silastic ® | 1:1 | Uvinul 400 | 5 | Syl-off ® | 50 |
| | 595 LSR | | | | 7611² | |
| 17 | SLE 5100, | 10:1 | Uvinul 400 | 5 | Sylox ® 2³ | 8 |
| | Liquid BC-10 | 1:1 | | | | |
| 18 | Silopren ® | 1:1 | Uvinul 400 | 5 | Hydral ® | 10 |
| | LSR 2530 | | | | 710⁴ | |
| 19 | Silopren ® | 1:1 | Uvinul 400 | 5 | Silopren ® | 1 |
| | LSR 1530 | | | | LSR Z3042⁵ | |
| 20 | SLE 5500 | 10:1 | Uvinul 400 | 5 | | |
| 21 | Silopren ® | 1:1 | Uvinul 400 | 5 | | |
| | 2430 | | | | | |
| 22 | SLE 5300 | 10:1 | Uvinul 400 | 5 | | |
| 23 | SLE 5106 | 10:1 | Uvinul 400 | 5 | | |
| 24 | Silopren ® | 1:1 | Uvinul 400 | 5 | Flattening | 4 |
| | LSR 2530 | | | | Agent | |
| | | | | | OK412 ®⁶ | |
| 25 | Silopren ® | 1:1 | Uvinul 400 | 5 | Nalco ® | 50 |
| | LSR 2530 | | | | 1SJ-612 | |
| | | | | | Colloidal | |
| | | | | | Silica⁷ | |
| 26 | Silopren ® | 1:1 | Uvinul 400 | 5 | Nalco ® | 50 |
| | LSR 2530 | | | | 1SJ-612 | |
| | | | | | Colloidal | |
| | | | | | Alumina⁸ | |
| 27 | Silastic ® | 1:1 | Uvinul 400 | 5 | 200 Fluid⁹ | 7 |
| | 595 LSR | | | | | |
| 28 | Silopren ® | 1:1 | Uvinul 400 | 5 | | |
| | LSR 2530 | | | | | |
| 29 | Silastic ® | 1:1 | Uvinul 400 | 5 | Zepel ® | 3 |
| | 595 LSR | | | | 7040¹⁰ | |
| 30 | Silastic ® | 1:1 | Uvinul 400 | 5 | Zonyl ® | 1/10 |
| | 595 LSR | | | | UR¹¹ | |
| 31 | Silastic ® | 1:1 | Uvinul 400 | 5 | Zonyl ® | 1/10 |
| | 595 LSR | | | | FSN-100¹² | |
| 32 | Silopren ® | 1:1 | Uvinul 400 | 5 | DLX- | 5 |
| | LSR 2530 | | | | 600 ®¹³ | |
| 33 | Silopren ® | 1:1 | Uvinul 400 | 5 | TE-3608 ®¹⁴ | 5 |
| | LSR 2530 | | | | | |

¹7127 Accelerator (Dow Corning) is a polysiloxane
²Syl-off ® (Dow Corning) is a cross-linker
³Sylox ® 2 (W.R. Grace & Co.) is a synthetic amorphous silica
⁴Hydral ® 710 (Alcoa) is a hydrated aluminum oxide
⁵Silopren ® LSR Z3042 (Mobay) is a silicone primer (bonding agent) mixture
⁶Flattening Agent OK412 ® (Degussa Corp.) is a wax coated silicon dioxide
⁷Nalco ® 1SJ-612 Colloidal Silica (Nalco Chemical Co.) is an aqueous solution of silica and alumina
⁸Nalco ® 1SJ-612 Colloidal Alumina (Nalco Chemical Co.) is an aqueous colloidal alumina dispersion
⁹200 Fluid (Dow Corning) is a 100 cps viscosity dimethylpolysiloxane
¹⁰Zepel ® 7040 (DuPont) is a nonionic fluoropolymer
¹¹Zonyl ® UR (DuPont) is an anionic fluorosurfactant
¹²Zonyl ® FSN-100 (DuPont) is a nonionic fluorosurfactant
¹³DLX-600 ® (DuPont) is a polytetrafluoroethylene micropowder
¹⁴TE-3608 ® (DuPont) is a polytetrafluoroethylene micropowder

The silicone polymer resin and other components are mixed using a flockmayer F dispersion blade at low torque and high shear. The fire retardant and heat resistant fabric is tensioned and passed through a bath containing the silicone resin composition. Localized high shear is applied to the silicone resin composition near the surface of the fabric in order to coat the yarn strands comprising the fabric at a rate of 1.0 oz/sq. yd. The fabric is passed through the polymer resin composition several times to ensure thorough impregnation. After impregnation, the impregnated fabric is removed from the silicone polymer composition bath and passed through a line oven of approximately 10 yards in length, at 4-6 yards per minute, and cured at a temperature of 325-350° F.

### Examples 34-60

Various treated fire retardant and heat resistant fabrics are manufactured according to any of Examples 8-14. The fluorochemical compositions used to pretreat the fire retardant and heat resistant fabric(s) according to Examples 34-60 prior to application of the silicone resin composition (which may comprise any of the compositions of Examples 15-33 in Table I) are set forth in Table II below.

TABLE II

| Example | Flurochemical |
|---|---|
| 34 | Milease ® F-14N |
| 35 | Milease ® F-34 |
| 36 | Milease ® F-31X |
| 37 | Milease ® F-53 |
| 38 | Phobotex ® FC104 |
| 39 | Phobotex ® FC461 |
| 40 | Phobotex ® FC731 |
| 41 | Phobotex ® FC208 |
| 42 | Phobotex ® FC232 |
| 43 | Teflon ® G |
| 44 | Teflon ® NPA |
| 45 | Teflon ® SKF |
| 46 | Teflon ® UP |
| 47 | Teflon ® UPH |
| 48 | Teflon ® PPR |
| 49 | Teflon ® N |
| 50 | Teflon ® MLV |
| 51 | Zepel ® B |
| 52 | Zepel ® D |
| 53 | Zepel ® K |
| 54 | Zepel ® RN |
| 55 | Zepel ® RC |
| 56 | Zepel ® OR |
| 57 | Zepel ® HT |
| 58 | Zepel ® 6700 |
| 59 | Zepel ® 7040 |
| 60 | Scotchguard ® |

Prior to applying the fluorochemical composition, the fire retardant and heat resistant fabric is washed with detergent, rinsed thoroughly, and hung to air dry. Thereafter, the fabric is soaked in water and then wrung dry to retain 0.8 g water/g fabric (e.g., using a 2.5% solution of the fluorochemical). The pretreated fabric is wrung through a wringer and air dried. The fabric is then heated in an oven for 1 minute at 350° F. to remove any remaining solvent and sinter the fluorochemical. The fluorochemical treated fabric is then coated with a silicone polymer composition (e.g., a composition from one of Example 15-33.

### Example 61

Various treated liquid, gel, spark, and molten metal-shedding and strengthened fire retardant and heat resistant fabrics are manufactured using the fabrics disclosed in Examples 1-7, the silicone resin compositions of Examples 15-33, and the fluorochemical compositions of Examples 34-60 (i.e., a wide range of different liquid, gel, spark, and molten metal-shedding and strengthened fire retardant and heat resistant fabrics are manufactured using every possible combination of fabrics, silicone resin compositions, and fluorochemical compositions of Examples 1-7, 15-33 and 34-60, respectively).

The fire retardant and heat resistant fabrics treated according to the foregoing examples have increased tensile strength, abrasion resistance, durability and liquid, gel, spark, and molten metal-shedding properties compared to the fabrics prior to treating with the silicone-based polymer. Because the silicone-based polymer only encapsulates the individual yarn strands but not the pores or spaces between the overlapping yarn strands, the treated fabrics retain a level of breathability and porosity. In addition, the elastomeric properties of the silicone-based polymer allow the fabrics to retain a level of flexibility and suppleness, which helps maintain the comfort of the fabrics if worn against a person's body.

The fabrics can be used in the manufacture of a wide variety of clothing and other articles where high fire retardance, heat resistance, and liquid, gel, spark, and molten metal shedding capabilities are desirable. Examples include, but are not limited to, clothing, jump suits, gloves, socks, welding bibs, welding sleeves, welding mask shrouds (e.g., to protect the neck), breacher's coats (e.g., as worn by military or other personnel while cutting through metal), fire blankets, padding, protective head gear, linings, undergarments, bedding, drapes, and the like. The treated fabrics and articles are especially useful in the case where the wearer may be contacted by sparks or molten metal (e.g., steel workers, welders, firemen), or be coated or doused with a flammable liquid or gel, such as a policemen or soldier hit with a Molotov cocktail or other incendiary device.

### Example 62

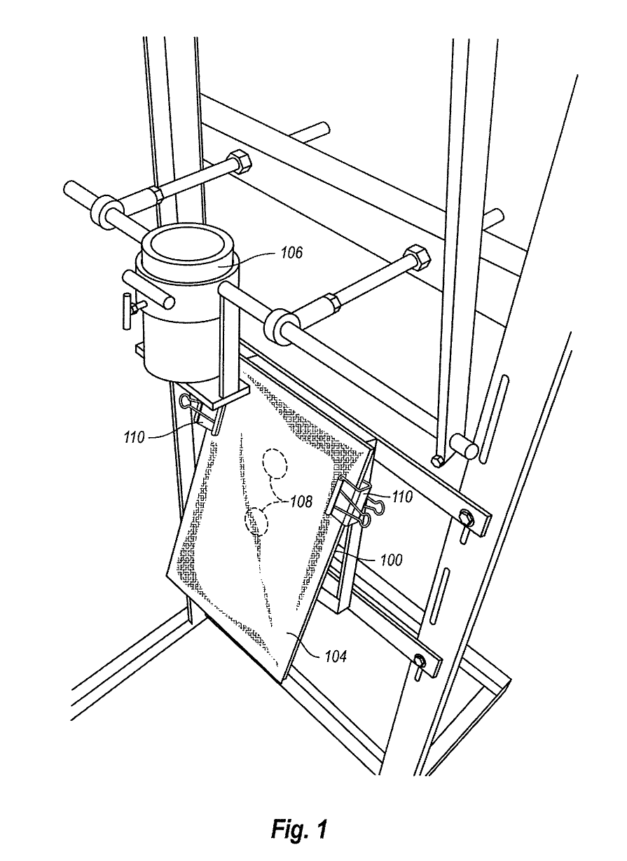

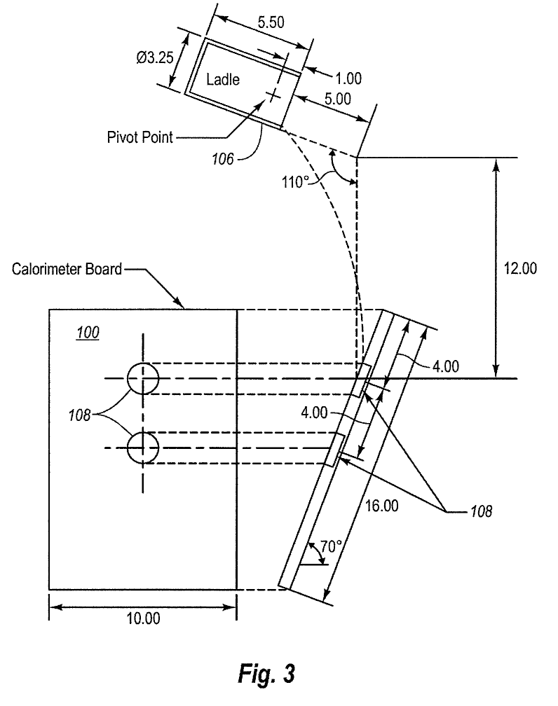

A fabric (referred to hereafter as C59) comprising a 86:14 wt % blend of O-Pan and p-aramid without a silicone-based polymer coating was tested as compared to the same fabric (referred to hereafter as C59E) with a silicone-based polymer coating. The testing was in accordance with ASTM standard F955-03 entitled “Evaluating Heat Transfer through Materials for Protective Clothing upon Contact with Molten Substances.” The standardized conditions for molten iron impact evaluations include pouring 1 kg±0.1 kg of molten iron at a minimum temperature of 2800° F. onto fabric samples attached to a calorimeter board. The testing set up is shown in FIGS. 1-3. The calorimeter board 100 was oriented at an angle of 70° from the horizontal and molten metal 102 dropped from a height of 12 inches onto a fabric sample 104 placed over calorimeter board 100. The ladle 106 containing the molten metal was rotated against a rigid stop and the molten metal 102 dumped onto the test fabric 104. The orientation of the ladle 106, calorimeter board 100, and calorimeters 108 before dumping is illustrated in FIG. 1.

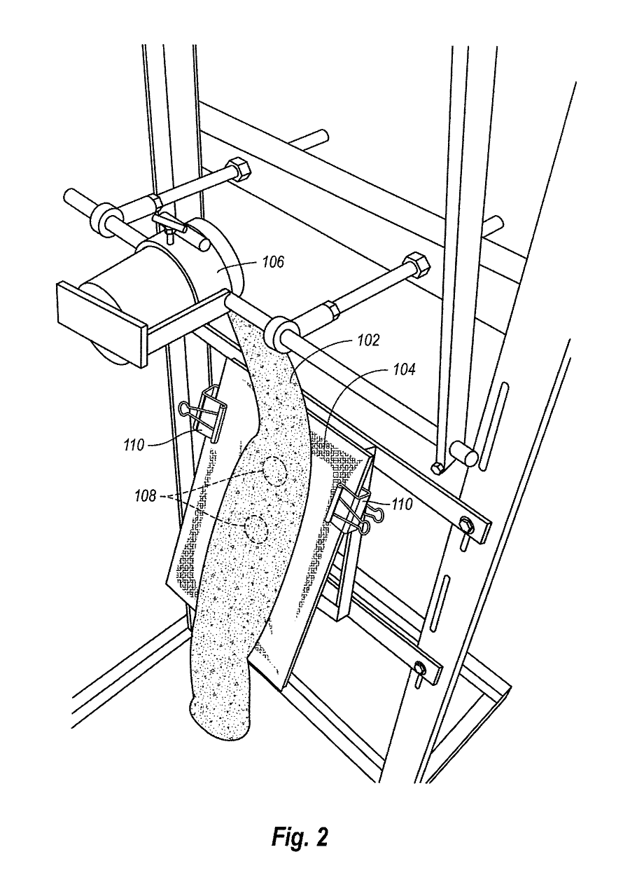

Each fabric 104 to be tested was placed on the calorimeter board 100 and held in place with clips 110 along the upper edge of board 100. A preheated ladle 106 was filled with molten iron 102 from an induction furnace held at a temperature of approximately 2925° F. The molten metal weight was determined with an electronic balance and was maintained at 1 kg±0.1 kg. The filled ladle 106 was transferred to the ladle holder and splashed onto the fabric (FIG. 2). A fixed delay of 25 seconds after the start of the furnace pour was used to maintain a consistent metal impact temperature. Empirical testing has shown that metal temperature decreases by approximately 75-100° F. after the 25 second delay. The molten metal 102 was poured from the ladle 106 onto the fabric 104 and the results assessed. Each fabric 104 was tested using an undergarment consisting of a single layer of all-cotton T-shirt.

Visual examination was conducted on the impact fabric 104 for each sample tested. The visual appearance of each fabric 104 was subjectively rated in four categories after impact with molten metal 102. These categories were (1) charring, (2) shrinkage, (3) metal adherence, and (4) perforation. The rating system is outlined below, and the results are presented in Table III, below.

The char rating describes the extent of scorching, charring, or burning sustained by the fabric. The shrinkage rating provides indication of the extent of the fabric wrinkling caused by shrinkage occurring around the area of metal impact. It is desirable to have a minimum amount of charring, wrinkling, and shrinkage during or after impact event. Metal adherence refers to the amount of metal sticking to the fabric. The perforation rating describes the extent of fabric destruction in terms of the size, number of holes created, and penetration of molten metal through the fabric. It is desirable to have no perforation or penetration of molten metal through the fabric. The rating system uses numbers one through five in each category, with “1” representing the best behavior and “5” representing worst behavior.

### Grading System Used to Evaluate Fabric Damage

The fabric samples were evaluated visually for charring, shrinkage, and perforation, to provide an indication of the extent of damage to the outer impacted layer. Five grades were used in evaluating the extent of charring:

1=slight scorching, fabric had small brown areas

2=slight charring, fabric was mostly brown in impacted area

3=moderate charring, fabric was mostly black in impacted area

4=charred, fabric was black and brittle, cracked when bent

5=severely charred, large holes or cracks, very brittle

Shrinkage was evaluated by laying the fabric on a flat surface and observing the extent of fabric wrinkling around the splash area. Shrinkage was evaluated using five categories:

1=no shrinkage

2=slight shrinkage

3=moderate shrinkage

4=significant shrinkage

5=extensive shrinkage

The adherence rating refers to the amount of metal sticking to the front of the fabric. Adherence of metal was rated using five categories:

1=none

2=small amount of metal adhered to face or back of fabric

3=a moderate amount of metal adhered to the fabric

4=substantial adherence of the metal to the fabric

5=large amount of adherence of metal to the fabric

Perforation was evaluated by observing the extent of destruction of the fabric, usually by holding it up to a light. Five grades were used in evaluating perforation:

1=none

2=slight, small holes impacted area

3=moderate, holes in fabric

4=metal penetration through the fabric, some metal retained on the fabric

5=heavy perforation, the fabric exhibited gaping holes or large cracks or substantial metal penetration to the back side

The results are presented in Table III, below:

TABLE III

| Material Designation | Charring | Shrinkage | Adherence | Perforation |
|---|---|---|---|---|
| C59 Run 1 | 4 | 2 | 2 | 2 |
| C59 Run 2 | 4 | 2 | 2 | 2 |
| C59E Run 1 | 3 | 1 | 1 | 1 |
| C59E Run 2 | 3 | 1 | 1 | 1 |
| C59E Run 3 | 3 | 1 | 1 | 3 |

The calorimeter board 100 to which the fabrics 104 were attached was constructed according to ASTM standard F955-03. The board 100 contained two 4 cm diameter, 1/16 inch thick copper disks 108. One copper disk was located at the point of molten metal impact, and the second was located 4 inches below the first. Each copper disk calorimeter 108 contained a single 30-gauge iron/constantan Type J thermocouple inserted into the back of the calorimeter 108. The thermocouple output from the calorimeter 108 was recorded with a high precision digital data acquisition system. The temperature rise for both calorimeters 108 was plotted for 45 seconds for each fabric sample tested. The total heat energy that flowed through the fabric was calculated at each time step using the following formula:

$$Q = \frac{m \times {C}_{p} \times ( {Temp}_{final} - {Temp}_{initial} )}{Area}$$

where:

Q=heat energy (J/cm²),

m=mass of copper slug (g),

Cₚ=average heat capacity of copper during the temperature rise (J/g° C.),

Temp_{final}=final temperature of calorimeter at time_{final} (° C.),

Tempᵢₙᵢₜᵢₐₗ=initial temperature of calorimeter at timeᵢₙᵢₜᵢₐₗ (° C.),

Area=area of copper calorimeter.

This heat energy curve was compared to an empirical human predicted second-degree skin burn injury model (Stoll Curve). The Stoll Curve was calculated from the following formula:

Stoll Curve (J/cm²)=5.0204(tⱼ^{0.2901})

where tⱼ is the time after molten metal impact.

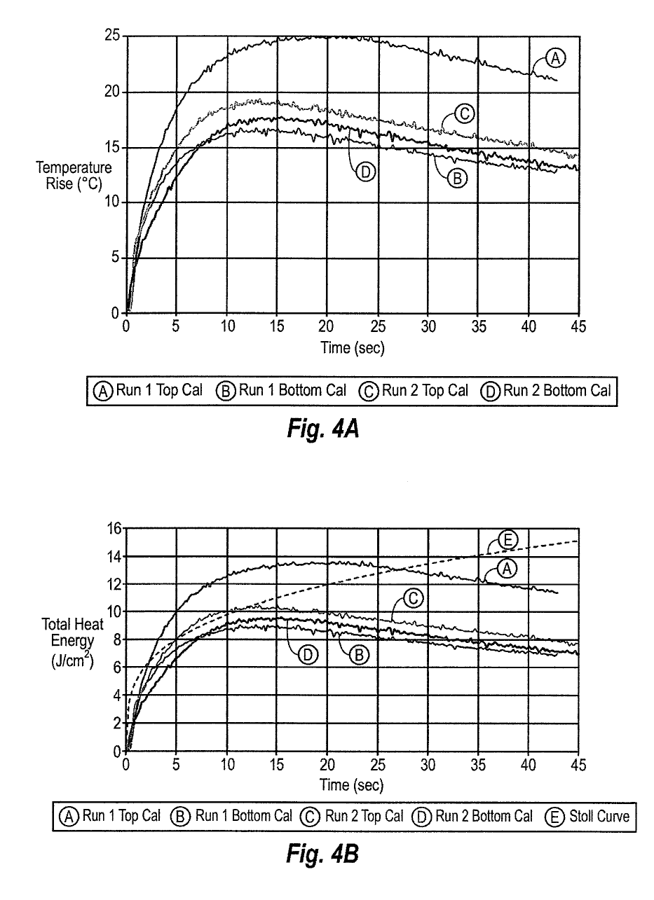

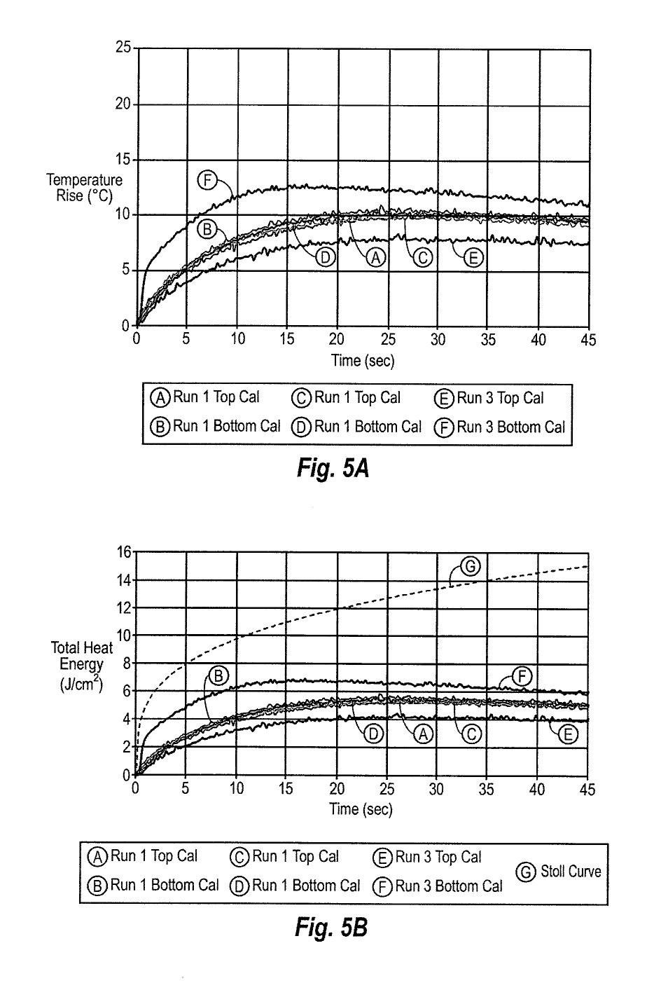

FIG. 4A shows temperature rise at each thermocouple through the C59 fabric not including a silicone-based polymer coating. FIG. 4B shows the heat transfer through the C59 fabric not including the silicone-based polymer coating, as well as the theoretical Stoll Curve. FIG. 5A shows temperature rise at each thermocouple through the C59E fabric including a silicone-based polymer coating. FIG. 5B shows the heat transfer through the C59E fabric including the silicone-based polymer coating, as well as the theoretical Stoll Curve. These results are summarized in Table IV below.

TABLE IV

| Material | Max. ΔT @ | Max. ΔT @ | Time to 2^{nd} |
|---|---|---|---|
| Designation | Top Calorimeter | Bottom Calorimeter | degree burn |
| C59 Run 1 | 25.2° C. | 16.7° C. | 2.2 seconds |
| C59 Run 2 | 19.3° C. | 17.7° C. | 4.8 seconds |
| C59E Run 1 | 10.3° C. | 10.9° C. | None |
| C59E Run 2 | 10.1° C. | 10.5° C. | None |
| C59E Run 3 | 8.3° C. | 12.8° C. | None |

As seen, the C59 fabrics alone are only able to slow the occurrence of a second degree burn, which would occur after 2.2 seconds and 4.8 seconds, respectively, according to the tests run. The C59E fabrics which include the silicone coating, on the other hand, will actually prevent the formation of a second degree burn to the wearer. This is a result of the synergistic combination of the C59 fabric and the silicone polymer coating. In short, the C59 fabric alone is not able to prevent the formation of a second degree burn. Similarly, the use of another fabric (e.g., cotton and/or nylon) encapsulated with silicone (as discussed in, e.g., U.S. Pat. Nos. 4,666,765, 5,004,643, 5,209,965, 5,418,051, 5,856,245, 5,869,172, 5,935,637, 6,040,251, 6,071,602, 6,083,602, 6,129,978, 6,289,841, 6,312,523, 6,342,280 and 6,416,613) would likewise not be able to prevent a second degree burn, as the molten iron would heat the inner core cotton or nylon material, at which point it would decompose or burn, and the fabric would be readily perforated. The surprising and particularly advantageous result of second degree burn prevention illustrated by the comparative example is possible because of the synergistic effects of the C59 O-Pan based fabric combined with the silicone-based polymer coating applied over the fabric. The silicone-based coating provides the coated fabric with an improved ability to shed the molten metal quickly, rather than allowing it to remain on the coated fabric surface, while the C59 O-Pan based fabric has sufficient fire retardance and heat resistance to maintain fabric integrity and minimize heat conduction to the underlying user's skin.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A shedding fire retardant and heat resistant article that sheds liquids, gels, sparks, and molten metal, the article comprising:
a fire retardant and heat resistant fabric or yarn comprised of:
one or more types of fire retardant and heat resistant polymer fibers and/or filaments having an LOI of at least about 50 and that do not burn when exposed to heat or flame having a temperature of about 3000° F.; and
one or more types of strengthening fibers and/or filaments; and
an outer layer coating at least a portion of the fabric or yarn, the outer layer comprising a liquid-shedding, gel-shedding, spark-shedding, and molten metal-shedding and strengthening polymer coating,
wherein the shedding fire retardant and heat resistant article has increased strength, abrasion resistance, durability and shedding ability compared to the fire retardant and heat resistant fabric or yarn in the absence of the outer lager coating.

2. A shedding fire retardant and heat resistant article as defined in claim 1, wherein the fire retardant and heat resistant polymer fibers and/or filaments comprise oxidized polyacrylonitrile.

3. A shedding fire retardant and heat resistant article as defined in claim 1, wherein the fire retardant and heat resistant fabric or yarn includes oxidized polyacrylonitrile in an amount in a range of about 25% to about 99.9% by weight of the fabric or yarn.

4. A shedding fire retardant and heat resistant article as defined in claim 1, wherein the fire retardant and heat resistant fabric or yarn includes oxidized polyacrylonitrile in an amount in a range of about 40% to about 95% by weight of the fabric or yarn.

5. A shedding fire retardant and heat resistant article as defined in claim 1, wherein the fire retardant and heat resistant fabric or yarn includes oxidized polyacrylonitrile in an amount in a range of about 50% to about 90% by weight of the fabric or yarn.

6. A shedding fire retardant and heat resistant article as defined in claim 1, wherein the strengthening fibers and/or filaments comprise at least one of p-aramid, m-aramid, polybenzimidazole, polybenzoxazole, polyphenylene-2,6-benzobisoxazole, modacrilic, polyvinyl halide, wool, fire resistant polyester, nylon, rayon, cotton, or melamine.

7. A shedding fire retardant and heat resistant article as defined in claim 1, wherein the fabric or yarn further comprises at least one metallic strengthening filament selected from steel, stainless steel, steel alloy, titanium, titanium alloy, aluminum, aluminum alloy, copper, or copper alloy.

8. A shedding fire retardant and heat resistant article as defined in claim 1, wherein the fabric or yarn further comprises at least one ceramic strengthening filament selected from silicon carbide, graphite, or a high strength ceramic that includes at least one oxide of Al, Zr, Ti, Si, Fe, Co, Ca, Nb, Pb, Mg, Sr, Cu, Bi, or Mn.

9. A shedding fire retardant and heat resistant article as defined in claim 1, wherein the liquid-shedding, gel-shedding, spark-shedding, and molten metal-shedding and strengthening polymer coating comprises at least one type of cured silicone polymer resin.

10. A shedding fire retardant and heat resistant article as defined in claim 1, further comprising at least one fluorochemical at least partially impregnated within the fabric or yarn that further imparts liquid, gel, spark, and molten metal-shedding capability to the shedding fire retardant and heat resistant article.

11. A shedding fire retardant and heat resistant article as defined in claim 1, wherein the outer layer comprises an outer shell that encapsulates at least a portion of the fabric or yarn strands.

12. A shedding fire retardant and heat resistant article as defined in claim 1, comprising a plurality of liquid-shedding, gel-shedding, spark-shedding, and molten metal-shedding fire retardant and heat resistant yarns that have been woven, knitted, or otherwise joined together into a fabric

13. A shedding fire retardant and heat resistant article as defined in claim 12, wherein the outer layer coats only one side of the fabric.

14. A shedding fire retardant and heat resistant article as defined in claim 1, wherein the article is selected from the group consisting of clothing, jump suit, glove, sock, welding bib, welding sleeve, welding mask shroud, breacher's coat, fire blanket, padding, protective head gear, lining, undergarment, bedding, and drape.

15. A shedding fire retardant and heat resistant article that sheds liquids, gels, sparks, and molten metal, the yarn comprising:
a fire retardant and heat resistant yarn comprised of polyacrylonitrile fibers and/or filaments;
at least one fluorochemical at least partially impregnated within the yarn; and
an outer layer coating at least a portion of the yarn comprised of a liquid-shedding, gel-shedding, spark-shedding, and molten metal-shedding and strengthening silicone polymer coating,
wherein the shedding fire retardant and heat resistant article has increased strength, abrasion resistance, durability and shedding ability compared to the fire retardant and heat resistant yarn in the absence of the outer layer.

16. A shedding fire retardant and heat resistant article as defined in claim 15, the fire retardant and heat resistant yarn further comprising one or more types of strengthening fibers and/or filaments selected from the group consisting of p-aramid, m-aramid, polybenzimidazole, polybenzoxazole, polyphenylene-2,6-benzobisoxazole, modacrilic, polyvinyl halide, wool, fire resistant polyester, nylon, rayon, cotton, and melamine.

17. A shedding fire retardant and heat resistant article that sheds liquids, gels, sparks, and molten metal, the article comprising:
a fire retardant and heat resistant fabric formed from a plurality of fire retardant and heat resistant yarn strands woven, knitted or otherwise joined together to form the fabric, wherein the fire retardant and heat resistant yarn strands are comprised of polyacrylonitrile fibers and/or filaments, wherein the fabric includes spaces between the yarn strands; and
a liquid, spark, and molten metal-shedding and strengthening outer layer coating at least a portion of the fabric, wherein the outer layer is comprised of a liquid, gel, spark, and molten metal-resistant and strengthening polymer coating that is applied so that the fabric maintains spaces between the yarn strands and remains porous and breathable,
wherein the shedding fire retardant and heat resistant article has increased strength, abrasion resistance, durability and shedding ability compared to the fire retardant and heat resistant fabric in the absence of the outer layer.

18. A shedding fire retardant and heat resistant article as defined in claim 17, the fire retardant and heat resistant yarn strands further comprising one or more types of strengthening fibers and/or filaments selected from the group consisting of p-aramid, m-aramid, polybenzimidazole, polybenzoxazole, polyphenylene-2,6-benzobisoxazole, modacrilic, polyvinyl halide, wool, fire resistant polyester, nylon, rayon, cotton, and melamine.

19. A shedding fire retardant and heat resistant article as defined in claim 17, wherein the polymer coating comprises at least one type of cured silicone polymer resin.

20. A shedding fire retardant and heat resistant article as defined in claim 17, further comprising at least one fluorochemical at least partially impregnated within the fire retardant and heat resistant yarn strands that further imparts liquid, gel, spark, and molten metal shedding capability to the shedding fire retardant and heat resistant article.

21. A shedding fire retardant and heat resistant article as defined in claim 17, wherein the outer layer comprises an outer shell that encapsulates at least a portion of the yarn strands.

22. A shedding fire retardant and heat resistant article as defined in claim 17, wherein the outer layer coats only one side of the fabric.

23. A shedding fire retardant and heat resistant article as defined in claim 17, wherein the article is selected from the group consisting of clothing, jump suit, glove, sock, welding bib, welding sleeve, welding mask shroud, breacher's coat, fire blanket, padding, protective head gear, lining, undergarment, bedding, and drape.
